(19) United States
(12) Patent Application Publication
(10) Pub. No.: US 2025/0095935 A1
(43) Pub. Date: Mar. 20, 2025

(54) RELAY

(71) Applicant: Xiamen Hongfa Electric Power Controls Co., Ltd., Xiamen (CN)

(72) Inventors: Wenguang Dai, Xiamen (CN); Dapeng Fu, Xiamen (CN); Yiwen Wu, Xiamen (CN); Liji Su, Xiamen (CN)

(21) Appl. No.: 18/883,799

(22) Filed: Sep. 12, 2024

(30) Foreign Application Priority Data
Sep. 14, 2023 (CN) 2023111897467

(51) Int. Cl. H01H 45/02; H01H 45/14

(52) U.S. Cl. CPC H01H 45/02; H01H 45/14

(57) ABSTRACT

A relay includes a movable contact assembly including a movable contact piece; a push rod assembly configured to push the movable contact assembly to move so that the movable contact piece contacts with or separates from a static contact leading-out terminal; and an elastic assembly connected to the push rod assembly through a first anti-rotation structure and connected to the movable contact assembly through a second anti-rotation structure, the elastic assembly is configured to provide contact pressure and to limit the movable contact assembly from rotating relative to the push rod assembly around an axis of the push rod assembly.

### CROSS REFERENCE

This application is based upon and claims priority to Chinese Patent Application No. 2023111897467, filed on Sep. 14, 2023, the entire contents thereof are incorporated herein by reference.

### TECHNICAL FIELD

The present disclosure relates to the technical field of electronic control devices, and more specifically, to a relay.

### BACKGROUND

A relay is an electronic control device that has a control system (also known as an input circuit) and a controlled system (also known as an output circuit). It is usually used in automatic control circuits. A relay is actually an “automatic switch” that uses a smaller current to control a larger current. Therefore, it plays the role of automatic adjustment, safety protection, and circuit conversion in the circuit.

A voltage DC relay is a type of relay. In the prior art, the voltage DC relay includes a pair of static contact leading-out terminals and a movable assembly. The movable assembly includes a movable contact piece and a push rod assembly, and the movable contact piece is installed on the push rod assembly through an elastic assembly. In the over-travel stage, the movable contact piece is in contact with the pair of static contact leading-out terminals, the push rod assembly will continue to move upward, and the elastic assembly will be compressed to form contact pressure.

However, the movable contact piece of the voltage DC relay in the prior art is easy to rotate relative to the push rod assembly, causing the movable contact piece to deflect excessively, thereby causing the contact positions of the movable contact and the static contact to be inconsistent, thereby causing the contact resistance to be unstable, affecting the reliability of the relay.

### SUMMARY

The relay of the embodiment of the present disclosure includes:
a movable contact assembly including a movable contact piece;
a push rod assembly configured to push the movable contact assembly to move so that the movable contact piece contacts with or separates from a static contact leading-out terminal; and
an elastic assembly connected to the push rod assembly through a first anti-rotation structure and connected to the movable contact assembly through a second anti-rotation structure, the elastic assembly is configured to provide a contact pressure and to limit the movable contact assembly from rotating relative to the push rod assembly around an axis of the push rod assembly.

According to some embodiments of the present disclosure, wherein the relay further includes a pair of static contact leading-out terminals, and two ends of the movable contact piece along a first direction are configured to respectively contact with or separate from the pair of static contact leading-out terminals; wherein the first direction is an arrangement direction of the pair of static contact leading-out terminals;
the elastic assembly is an elastic piece, and the elastic piece includes a base portion, a connection portion and a deformation portion;
two ends of the base portion along the first direction are respectively provided with the connection portion and the deformation portion, the base portion is connected to the connection portion through the deformation portion, and the base portion is connected to the push rod assembly through the first anti-rotation structure;
the connection portion of the elastic piece is connected to the movable contact assembly through the second anti-rotation structure; wherein the deformation portion is configured to generate deformation to provide the contact pressure.

According to some embodiments of the present disclosure, wherein along the first direction, the connection portion located at one side of the base portion and the movable contact assembly form a first joint, the connection portion located at another side of the base portion and the movable contact assembly form a second joint, there is a first distance between the first joint and the second joint, there is a second distance between the deformation portions on both sides of the base portion, and the first distance is smaller than the second distance;
wherein the second distance is a maximum distance between the deformation portions on both sides of the base portion.

According to some embodiments of the present disclosure, wherein each deformation portion includes:
a first section, one end of the first section is connected to the base portion;
a second section, one end of the second section is connected to another end of the first section; the second section is bent from the first section in a direction away from the movable contact assembly, and the second sections on both sides of the base portion are inclined relative to the axis of the push rod assembly in a direction away from each other; and
a third section, one end of the third section is connected to another end of the second section; the third section is bent from the second section toward the direction close to the movable contact assembly, and the third sections on both sides of the base portion are inclined relative to the axis of the push rod assembly in a direction close to each other;
wherein another end of the third section is connected to the connection portion, and the connection portions on both sides of the base portion extend from the third section in a direction close to each other.

According to some embodiments of the present disclosure, wherein each deformation portion includes:
a fourth section, one end of the fourth section is connected to the base portion;
a fifth section is arc-shaped; one end of the fifth section is connected to another end of the fourth section; the fifth section extends from the fourth section along an arc-shaped trajectory to the connection portion;
wherein connection portions on both sides of the base portion extend from the fifth section in a direction close to each other.

According to some embodiments of the present disclosure, wherein the relay further includes a pair of static contact leading-out terminals, and two ends of the movable contact piece along a first direction are configured to respectively contact with or separate from the pair of static contact leading-out terminals; wherein the first direction is an arrangement direction of the pair of static contact leading-out terminals;
the elastic assembly is an elastic piece, and the elastic piece includes a base portion, a connection portion and a deformation portion;
both ends of the base portion along the first direction are respectively provided with the connection portion and the deformation portion, the base portion is connected to the connection portion through the deformation portion, and the base portion is connected to the movable contact assembly through the second anti-rotation structure;
the connection portion of the elastic piece is connected to the push rod assembly through the first anti-rotation structure; wherein the deformation portion is configured to generate deformation to provide the contact pressure.

According to some embodiments of the present disclosure, wherein the elastic assembly is connected to the movable contact piece through the second anti-rotation structure.

According to some embodiments of the present disclosure, wherein the relay further includes a first magnetizer, the first magnetizer is disposed at a side of the movable contact piece facing the static contact leading-out terminal.

According to some embodiments of the present disclosure, wherein, the movable contact assembly further includes a second magnetizer, the second magnetizer is fixedly connected to a side of the movable contact piece facing away from the static contact leading-out terminal; the second magnetizer is configured to form a magnetic circuit with the first magnetizer;
the elastic assembly is connected to the second magnetizer through the second anti-rotation structure.

According to some embodiments of the present disclosure, wherein the first anti-rotation structure includes:
at least two first limiting holes provided on one of the elastic assembly and the push rod assembly; and
at least two first limiting protrusions arranged on another one of the push rod assembly and the elastic assembly; the at least two first limiting protrusions are inserted into the at least two first limiting holes.

According to some embodiments of the present disclosure, wherein the elastic assembly is an elastic piece, and the elastic piece is provided with the at least two first limiting holes;
one side surface of the elastic piece facing the movable contact assembly is provided with at least two protruding rings, the at least two protruding rings respectively surround the at least two first limiting holes, and an inner ring surface of the protruding ring is flush with a hole wall of the first limiting hole.

According to some embodiments of the present disclosure, wherein the protruding ring is formed by turning and bending an edge of the first limiting hole of the elastic piece in a direction closing the movable contact assembly.

According to some embodiments of the present disclosure, wherein the second anti-rotation structure includes:
at least two second limiting holes provided on one of the elastic assembly and the movable contact assembly; and
at least two second limiting protrusions arranged on another one of the movable contact assembly and the elastic assembly; the at least two second limiting protrusions are inserted into at least two second limiting holes.

According to some embodiments of the present disclosure, wherein the relay further includes a pair of static contact leading-out terminals, and two ends of the movable contact piece along a first direction are configured to contact with or separate from the pair of static contact leading-out terminals respectively; wherein the first direction is an arrangement direction of the pair of static contact leading-out terminals;
each second limiting hole is elliptical, and a major axis of the ellipse is parallel with the first direction.

According to some embodiments of the present disclosure, wherein the relay further includes a pair of static contact leading-out terminals, and two ends of the movable contact piece along a first direction are configured to contact with or separate from the pair of static contact leading-out terminals respectively; wherein the first direction is an arrangement direction of the pair of static contact leading-out terminals;
the elastic assembly and the movable contact assembly are connected in a limited way along the first direction; and/or, the elastic assembly and the push rod assembly are connected in a limited way along the first direction.

According to some embodiments of the present disclosure, wherein the push rod assembly includes a contact bracket, the movable contact assembly includes one or more movable contact pieces, and the movable contact assembly is installed in the contact bracket through the elastic assembly.

### BRIEF DESCRIPTION OF THE DRAWINGS

FIG. 1 is a schematic structure diagram of the relay according to a first exemplary embodiment.

FIG. 2 is a cross-sectional view along line A-A in FIG. 1.

FIG. 3 is a cross-sectional view along line B-B in FIG. 1.

FIG. 4 is a schematic structure diagram of the movable assembly according to an exemplary embodiment.

FIG. 5 is a schematic structure diagram of the push rod according to an exemplary embodiment.

FIG. 6 is a schematic structure diagram of FIG. 4, wherein the contact bracket is omitted, the movable contact piece has not yet contacted the static contact leading-out terminal.

FIG. 7 is a schematic structure diagram of the elastic piece according to an exemplary embodiment.

FIG. 8 is an exploded schematic diagram of the movable assembly of a relay and two second magnetizers according to a first exemplary embodiment.

FIG. 9 is a cross-sectional view along line C-C in FIG. 4.

FIG. 10 is a partial enlarged view of X in FIG. 9.

FIG. 11 is an exploded view of the movable assembly and two second magnetizers of the relay according to the second exemplary embodiment.

FIG. 12 is a schematic structure diagram of FIG. 11, wherein the contact bracket is omitted.

FIG. 13 is an exploded view of the movable assembly and two second magnetizers according to the third exemplary embodiment.

FIG. 14 is an exploded view of the movable assembly and two second magnetizers according to the fourth exemplary embodiment.

FIG. 15 is a schematic structure diagram of FIG. 4 omitting the contact bracket, wherein the contact bracket is omitted, and the movable contact piece has been in contact with the static contact leading-out terminal.

FIG. 16 is a cross-sectional view along line D-D in FIG. 15, wherein the movable contact is not in contact with the static contact.

FIG. 17 is a cross-sectional view along line D-D in FIG. 15, wherein the movable contact is in contact with the static contact.

Wherein, the reference numerals are listed as follows:

1000, contact container; 1001, contact chamber; 1002, first through hole; 1100, insulating cover; 1110, ceramic cover; 1111, third through hole; 1120, frame piece; 1200, yoke plate; 1210, second through hole; 2000, static contact leading-out terminal; 3000, movable assembly; 3100, movable contact assembly; 3110, movable contact piece; 3111, second limiting protrusions; 3200, push rod assembly; 3210, push rod; 3211, base; 3212, rod portion; 3213, clamping sheet; 3214, first limiting protrusions; 3220, contact bracket; 3221, top wall; 3222, side wall; 3223, clamping hole; 3230, elastic assembly; 4000, magnetic circuit part; 4100, bobbin; 4200, coil; 4300, static iron core; 4400, movable iron core; 4410, penetrating hole; 4500, reset piece; 5000, metal cover; 6100, first magnetizer; 6200, second magnetizer; 6300, connection piece; 100, elastic piece; 110, base portion; 111, first limiting holes; 112, protruding ring; 112a, top surface; 112b, inner ring surface; 113, chamfer; 120, connection portion; 121, second limiting holes; 130, deformation portion; 131, first section; 132, second section; 133, third section; 134, fourth section; 135, fifth section; 136, first bending joint; 137, second bending joint; 138, third bending joint; 200, accommodation chamber; 300, first anti-rotation structure; 400, second anti-rotation structure; 400a, first joint; 400b, second joint; L1, first distance; L2, second distance.

### DETAILED DESCRIPTION

Example embodiments will now be described more fully with reference to the accompanying drawings. However, example embodiments can be implemented in many forms and should not be construed as limited to the embodiments set forth herein; rather, these embodiments are provided so that this application will be comprehensive and complete and fully convey the concept of the example embodiments to those skilled in the art. The same reference numerals in the figures represent the same or similar structures, and thus their detailed description will be omitted.

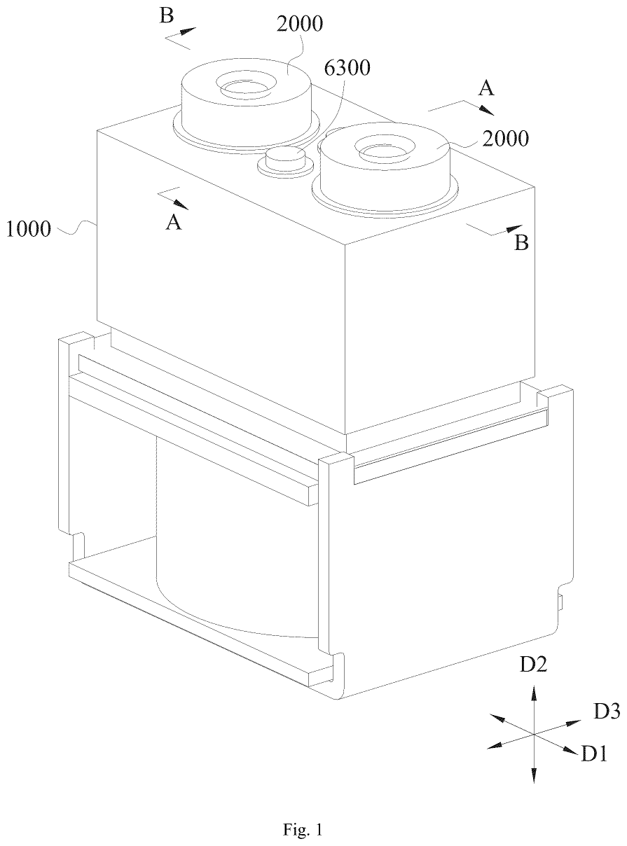

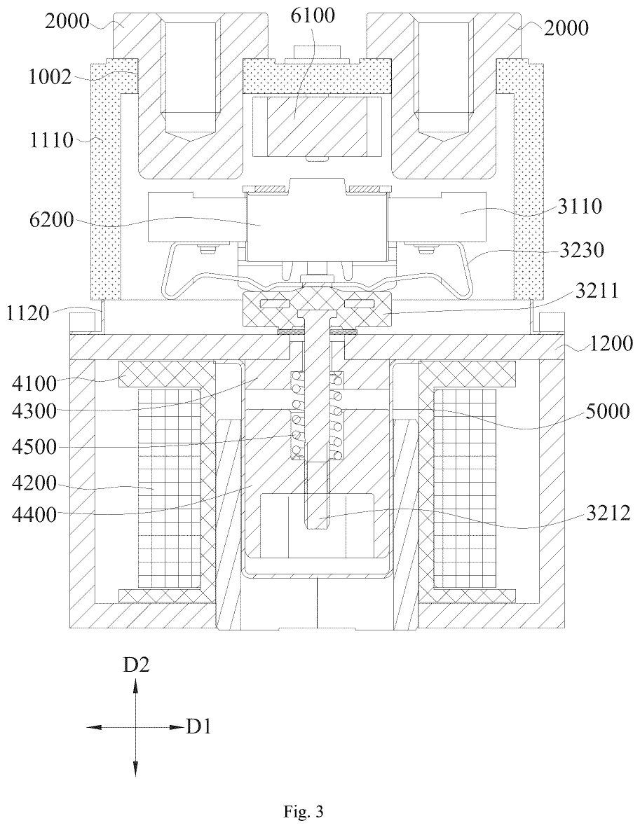

As shown in FIG. 1 to FIG. 3, the relay of the embodiment of the present disclosure includes a contact container 1000, a pair of static contact leading-out terminals 2000, a movable assembly 3000 and a magnetic circuit part 4000.

It is understood that the terms “include” and “have” and any of their variations used in the embodiments of the present disclosure are intended to cover non-exclusive inclusions. For example, a process, method, system, product, or apparatus that includes a series of steps or units is not limited to the listed steps or units, but may optionally include steps or units not listed, or may optionally include other inherent steps or components for these processes, methods, products, or apparatuses.

It should be noted that the contact container 1000 is a stationary component, which is used to accommodate the contact group and is mainly a housing with a chamber. In addition, the contact container 1000 can be composed of multiple components connected in a predetermined assembly manner.

The contact container 1000 has a contact chamber 1001 therein. The contact container 1000 may include an insulating cover 1100 and a yoke plate 1200. The insulating cover 1100 is covered on one side surface of the yoke plate 1200. The insulating cover 1100 and the yoke plate 1200 together enclose the contact chamber 1001.

The insulating cover 1100 includes a ceramic cover 1110 and a frame piece 1120. The ceramic cover 1110 is connected to the yoke plate 1200 through the frame piece 1120. The frame piece 1120 may be a metal piece of an annular structure, such as an iron-nickel alloy, and one end of the frame piece 1120 is connected to an opening edge of the ceramic cover 1110, for example, by laser welding, brazing, resistance welding, gluing, etc. The other end of the frame piece 1120 is connected to the yoke plate 1200, which may also be laser welding, brazing, resistance welding, gluing, etc. The frame piece 1120 is arranged between the ceramic cover 1110 and the yoke plate 1200, which can facilitate the connection between the ceramic cover 1110 and the yoke plate 1200.

The contact container 1000 also has a pair of first through holes 1002, the first through holes 1002 are communicated with the contact chamber 1001. The first through holes 1002 are used for the static contact leading-out terminal 2000 to pass through. In the embodiment of the present disclosure, the first through holes 1002 are opened on the ceramic cover 1110.

The pair of static contact leading-out terminals 2000 are connected to the ceramic cover 1110 of the contact container 1000, and at least a portion of each static contact leading-out terminal 2000 is located in the contact chamber 1001. One of the pair of static contact leading-out terminals 2000 is used as a terminal for current to flow in and the other is used as a terminal for current to flow out.

The pair of static contact leading-out terminals 2000 are respectively disposed in the pair of first through holes 1002 and connected to the ceramic cover 1110, for example, by welding.

The bottom of static contact leading-out terminal 2000 serves as a static contact, and the static contact may be integrally or separately arranged at the bottom of the static contact leading-out terminal 2000.

Continuing to refer to FIG. 1 to FIG. 3, the movable assembly 3000 includes a movable contact assembly 3100, a push rod assembly 3200 and an elastic assembly 3230. The movable contact assembly 3100 is disposed in the insulating cover 1100 and is mounted on the push rod assembly 3200 through the elastic assembly 3230. The two ends of the movable contact assembly 3100 along the first direction D1 are used to contact the pair of static contact leading-out terminals 2000 contact or separation. The first direction D1 is the arrangement direction of the pair of static contact leading-out terminals 2000.

The movable contact assembly 3100 includes a movable contact piece 3110, and the movable contact piece 3110 may include a movable piece body and movable contacts disposed at both ends of the movable piece body. The movable contact may be a separate part and connected to the movable piece body. Of course, the movable contact may also be integrally formed on the movable piece body.

The movable contact assembly 3100 includes at least one movable contact piece 3110, such as one, two, three, etc. In the embodiment of the present disclosure, the movable contact assembly 3100 includes two movable contact pieces 3110 arranged side by side. One end of the two movable contact pieces 3110 in the first direction D1 is used to contact with or separate from the static contact of one static contact leading-out terminal 2000, and the other end of the two movable contact pieces 3110 in the first direction D1 is used to contact with or separate from the static contact of another static contact leading-out terminal 2000.

The movable contact assembly 3100 may further include a second magnetizer 6200, the second magnetizer 6200 is fixedly connected to the movable contact piece 3110 facing away from the static contact leading-out terminal 2000. The role of the second magnetizer 6200 will be described below.

Wherein in the movable contact assembly 3100, the number of the movable contact piece 3110 is equal to the number of the second magnetizer 6200. Specifically, when the number of the movable contact piece 3110 is one, the number of the second magnetizer 6200 is also one; When the number of the movable contact piece 3110 is multiple (including two), the number of the second magnetizer 6200 is also multiple. The multiple second magnetizers 6200 are fixedly connected to multiple sides of the multiple movable contact pieces 3110 facing away from the static contact leading-out terminal 2000 in a one-to-one correspondence.

Of course, in other embodiments, when the number of the movable contact piece 3110 is one, the number of the second magnetizer 6200 may also be multiple, for example, at least one opening is provided in the middle of the movable contact piece 3110, and two adjacent second magnetizers 6200 among the multiple second magnetizers 6200 are inserted into one opening.

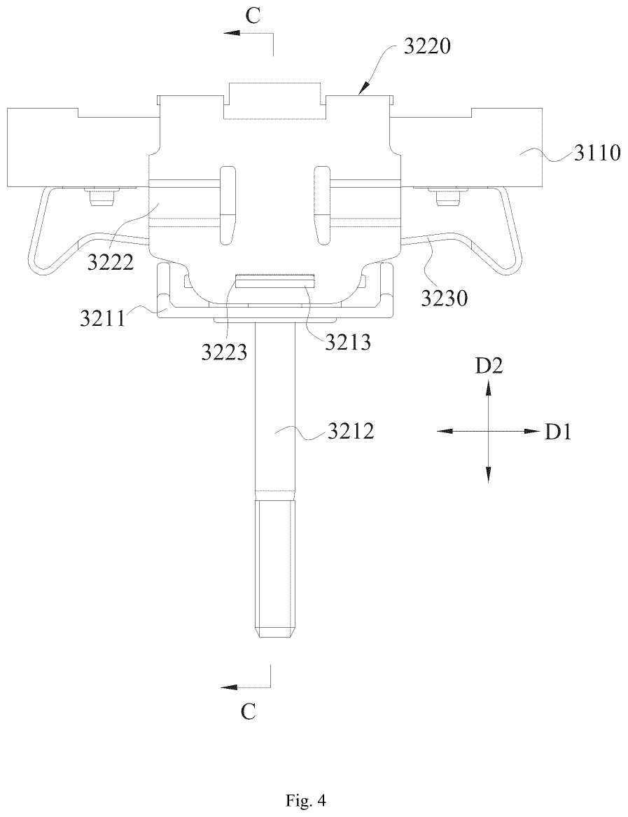

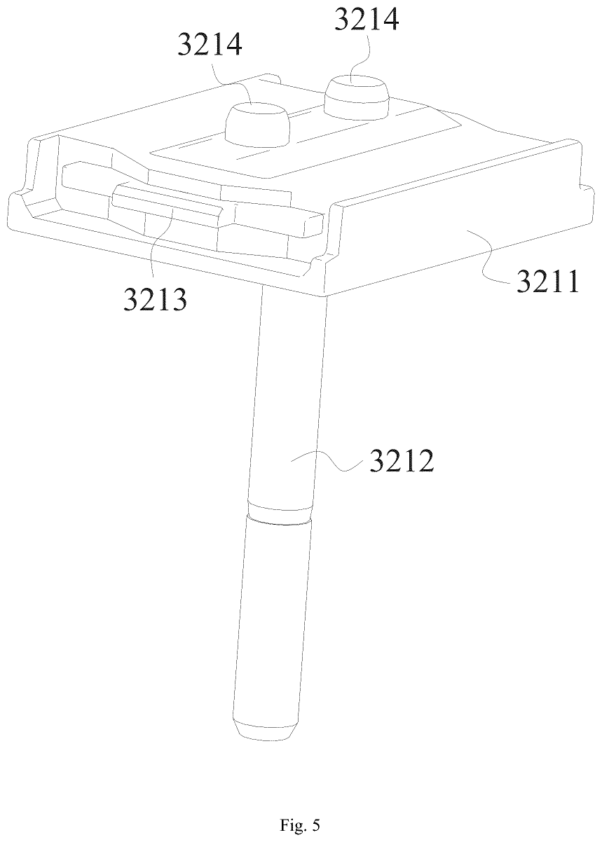

As shown in FIGS. 4 and 5, the moving direction of the movable contact piece 3110 is defined as the second direction D2, and the direction perpendicular to the first direction D1 and the second direction D2 is defined as the third direction D3. The push rod assembly 3200 includes a push rod 3210 and a contact bracket 3220, The contact bracket 3220 includes a top wall 3221 and two side walls 3222, and the two side walls 3222 are integrally connected to two side edges of the top wall 3221 along the third direction D3, that is, an inverted U-shaped bracket is formed. The movable contact piece 3110 is installed in the contact bracket 3220 through the elastic assembly 3230. The upper end of the push rod 3210 is connected to the bottom ends of the two side walls 3222 of the contact bracket 3220.

Each side wall 3222 of the contact bracket 3220 is provided with a clamping hole 3223. The push rod 3210 includes a base 3211 and a rod portion 3212, and the base 3211 is connected to one axial end of the rod portion 3212. Clamping sheets 3213 are provided on both sides of the base 3211, and two clamping sheets 3213 are respectively inserted into the two clamping holes 3223 of the contact bracket 3220 to fix the base 3211 and the contact bracket 3220. The elastic assembly 3230 is provided between the movable contact piece 3110 and the base 3211, and is used to apply an elastic force to the movable contact piece 3110 to move toward the top wall 3221. In the embodiment of the present disclosure, one end of the elastic assembly 3230 is connected to the movable contact assembly 3100 through the second anti-rotation structure 400, the other end of the elastic assembly 3230 is connected to the base 3211 through the first anti-rotation structure 300. The elastic assembly 3230 is used to provide contact pressure and to limit the rotation of the movable contact assembly 3100 relative to the push rod assembly 3200 around the axis of the push rod assembly 3200.

Of course, in other embodiments, the contact bracket 3220 can also be other structures, which are not listed here one by one.

Wherein when the number of the movable contact piece 3110 is multiple, the plurality of movable contact pieces 3110 are arranged side by side along the third direction D3.

Referring back to FIGS. 1 to 3, the yoke plate 1200 has a second through hole 1210, which penetrates two opposite sides of the yoke plate 1200 along the thickness direction of the yoke plate 1200, and the second through hole 1210 is communicated with the contact chamber 1001 of the contact container 1000. The rod portion 3212 is movably disposed in the second through hole 1210 in the axial direction. The base 3211 at one axial end of the rod portion 3212 is disposed in the contact chamber 1001.

The relay further includes a metal cover 5000. The metal cover 5000 is connected to the side of the yoke plate 1200 facing away from the insulating cover 1100, and the metal cover 5000 covers the second through hole 1210 on the yoke plate 1200. The metal cover 5000 and the yoke plate 1200 enclose a chamber for accommodating the static iron core 4300 and the movable iron core 4400 of the magnetic circuit part 4000.

The magnetic circuit part 4000 includes a bobbin 4100, a coil 4200, a static iron core 4300, a movable iron core 4400 and a reset piece 4500. The bobbin 4100 is in a hollow cylindrical shape and is formed of an insulating material. The metal cover 5000 is inserted into the bobbin 4100. The coil 4200 surrounds the bobbin 4100. The static iron core 4300 is fixedly arranged in the metal cover 5000, and a part of the static iron core 4300 extends into the second through hole 1210. The static iron core 4300 has a penetrating hole 4410 arranged corresponding to the position of the second through hole 1210, and is used for the rod portion 3212 to be inserted therein. The movable iron core 4400 is movably arranged in the metal cover 5000, and is arranged opposite to the static iron core 4300 along the axial direction of the rod portion 3212. The movable iron core 4400 is connected to the rod portion 3212 and is used to be attracted by the static iron core 4300 when the coil 4200 is energized. The movable iron core 4400 and the rod portion 3212 can be connected by threading, riveting, welding or other methods.

The reset piece 4500 is located inside the metal cover 5000 and is disposed between the static iron core 4300 and the movable iron core 4400, and is used to reset the movable iron core 4400 when the coil 4200 is powered off. The reset piece 4500 may be a spring and is sleeved outside the rod portion 3212.

It should be noted that when the coil 4200 is energized, the magnetic circuit part 4000 can drive the rod portion 3212 to push the push rod assembly 3200 to move upward. When the movable contact piece 3110 contacts the static contact leading-out terminal 2000, the movable contact piece 3110 is stopped by the static contact leading-out terminal 2000, while the rod portion 3212 and the base 3211 will continue to move upward until the over-travel is completed.

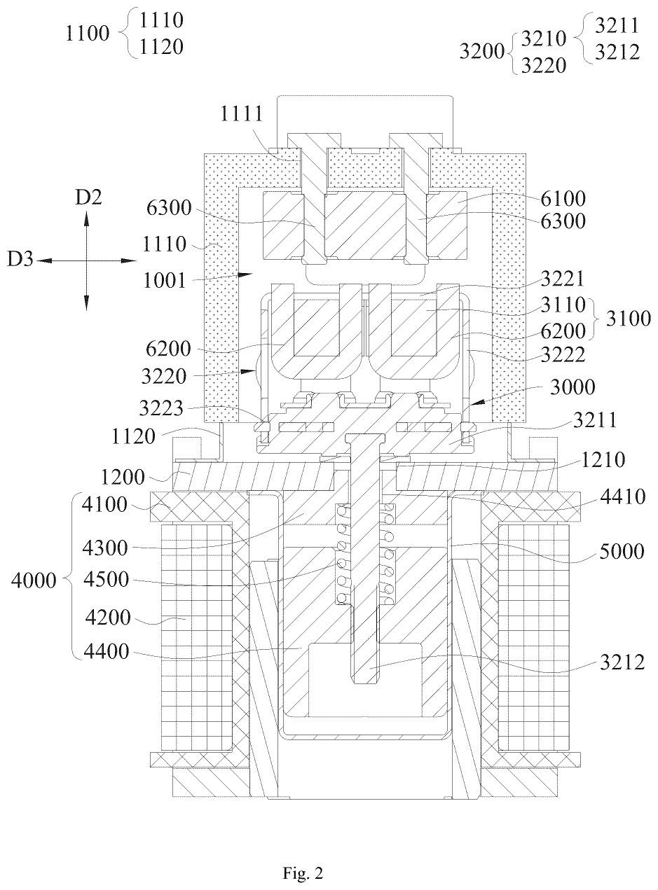

As shown in FIGS. 2 to 4, the relay of the embodiment of the present disclosure further includes a first magnetizer 6100. The movable contact piece 3110 has a first side and a second side disposed opposite to each other along the thickness direction of the movable contact piece 3110. Wherein the first side faces the static contact leading-out terminal 2000, and the second side faces away from the static contact leading-out terminal 2000. The first magnetizer 6100 is disposed at the first side of the movable contact piece 3110 and is disposed in the contact chamber 1001.

When the movable contact assembly 3100 includes only the movable contact piece 3110 but not the second magnetizer 6200, after the movable contact piece 3110 is energized, the first magnetizer 6100 is magnetized, thereby forming an attraction force on the movable contact piece 3110 in the contact closing direction, and the attraction force can resist the electric repulsion force generated by the short-circuit current between the movable contact piece 3110 and the static contact leading-out terminal 2000, thereby preventing the movable contact piece 3110 from bouncing off from the static contact leading-out terminal 2000, thereby achieving the purpose of resisting short circuit.

When the movable contact assembly 3100 includes the movable contact piece 3110 and the second magnetizer 6200, the second magnetizer 6200 is fixedly connected to the movable contact piece 3110, and the second magnetizer 6200 is used to form a magnetic circuit with the first magnetizer 6100.

When both ends of the movable contact piece 3110 are in contact with the pair of static contact leading-out terminals, the second magnetizer 6200 moving together with the movable contact piece 3110 approaches or contacts the first magnetizer 6100, thereby forming a magnetic circuit around the movable contact piece 3110 between the first magnetizer 6100 and the second magnetizer 6200. When the short-circuit current passes through the movable contact piece 3110, a magnetic attraction force is generated between the first magnetizer 6100 and the second magnetizer 6200 in the direction of the contact pressure, and the magnetic attraction force can resist the electric repulsion force generated by the short-circuit current between the movable contact piece 3110 and the static contact leading-out terminal 2000, which ensures that the movable contact piece 3110 and the static contact leading-out terminal 2000 do not bounce off.

It is understood that the second magnetizer 6200 and the movable contact piece 3110 may be fixedly connected by riveting, but is not limited thereto.

The first magnetizer 6100 and the second magnetizer 6200 can both be straight-line or U-shaped, and the first magnetizer 6100 and the second magnetizer 6200 can be made of magnetic conductive materials such as iron, cobalt, nickel, and alloys thereof.

Wherein when the movable contact assembly 3100 includes a plurality of the movable contact pieces 3110 arranged side by side, the number of the first magnetizers 6100 may be plural, and the number of the first magnetizers 6100 corresponds to the number of the movable contact pieces 3110, and the plurality of first magnetizers 6100 are respectively located on one side of the plurality of movable contact pieces 3110 facing the static contact leading-out terminal 2000.

Of course, in other embodiments, when the movable contact assembly 3100 includes a plurality of movable contact pieces 3110 arranged side by side, the number of the first magnetizer 6100 may be one, and the first magnetizer 6100 spans across the plurality of movable contact pieces 3110 in the third direction D3.

The first magnetizer 6100 may be connected to the contact container 1000 through two connection pieces 6300. One end of the two connection pieces 6300 is connected to the contact container 1000, and the other end of the two connection pieces 6300 is connected to the first magnetizer 6100.

It is understandable that the first magnetizer 6100 is connected to the contact container 1000 through the connection piece 6300, so that the magnetic attraction force for resisting short circuit is transferred to the contact container 1000. Since the contact container 1000 is a stationary component, there is no need for too much holding force of the coil, thereby reducing the power consumption of the coil of the relay and the volume of the relay, and improving the anti-short circuit ability.

In one embodiment, the connection piece 6300 is rod-shaped, one end of the connection piece 6300 along the axial direction is fixedly connected to the ceramic cover 1110 of the insulating cover 1100, and the other end of the connection piece 6300 along the axial direction is connected to the first magnetizer 6100.

In the embodiment of the present disclosure, the top wall of the ceramic cover 1110 of the contact container 1000 is provided with a third through hole 1111, and the connection piece 6300 is inserted through the third through hole 1111. The connection method between the end of the connection piece 6300 and the ceramic cover 1110 may be various, such as welding, riveting, threading, bonding, etc. The connection method between the other end of the connection piece 6300 and the first magnetizer 6100 can also may be various, such as welding, riveting, threading, bonding, clamping, etc.

It is understandable that when one end of the connection piece 6300 is connected to the ceramic cover 1110 by welding, by welding the connection piece 6300 to the top wall of the ceramic cover 1110, the metallization layer can be processed only on the periphery of the third through hole 1111 on the outer wall of the top wall, without processing the metallization layer on the inner wall of the top wall, which is convenient for processing and simplifies the processing steps.

It is understood that one end of the connection piece 6300 may be connected to the outer wall surface of the ceramic cover 1110, may be connected to the inner wall surface of the ceramic cover 1110, or may be connected to both the outer wall surface and the inner wall surface of the ceramic cover 1110.

In the embodiment of the present disclosure, one end of the connection piece 6300 is connected to the periphery of the third through hole 1111 of the ceramic cover 1110.

It can be seen that the first magnetizer 6100 is connected to the ceramic cover 1110 through the connection piece 6300. On the one hand, the magnetic attraction force for resisting short circuit is transferred to the ceramic cover 1110, so there is no need for too much holding force of the coil, thereby reducing the power consumption of the coil of the relay and the volume of the relay, and improving the anti-short circuit ability; on the other hand, since the connection piece 6300 is connected to the ceramic cover 1110, it will not occupy too much space in the contact chamber 1001, ensuring the arc extinguishing space of the arc extinguishing component and the activity space of the push rod.

In addition, the first magnetizer 6100 is connected to the rod-shaped connection piece 6300, so that the first magnetizer 6100 and the connection piece 6300 can be connected in a variety of ways, such as riveting, laser welding, clamping, gluing, etc., enriching the connection methods.

As an example, the connection piece 6300 is a solid rod. Thus, the connection piece 6300 and the first magnetizer 6100 can be connected by riveting, making the connection more reliable. In addition, the solid rod has a higher support strength and is less prone to deformation.

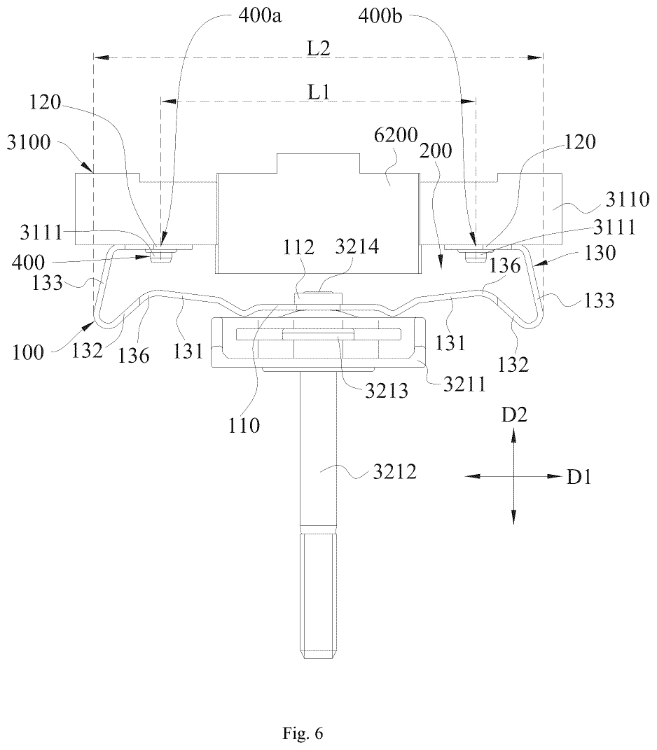

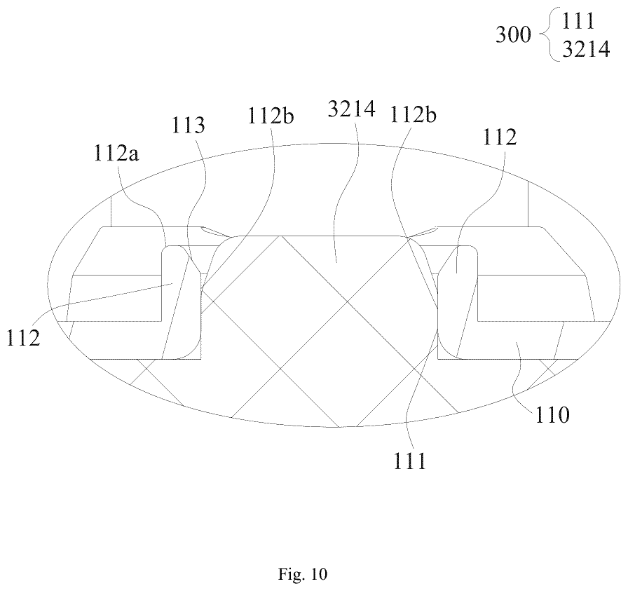

As shown in FIG. 6 and FIG. 10, the elastic assembly 3230 includes an elastic piece 100. As an example, the elastic piece 100 is a sheet structure made of a metal material and is formed by bending.

The elastic piece 100 includes a base portion 110, a connection portion 120 and a deformation portion 130. The base portion 110 is connected to the push rod 3210 through the first anti-rotation structure 300. Both sides of the base portion 110 along the first direction D1 are respectively provided with the connection portion 120 and the deformation portion 130, and the base portion 110 is connected to the connection portion 120 through the deformation portion 130. The connection portion 120 of the elastic piece 100 is connected to the movable contact assembly 3100 through the second anti-rotation structure 400. Wherein the deformation portion 130 is used to generate deformation to provide contact pressure.

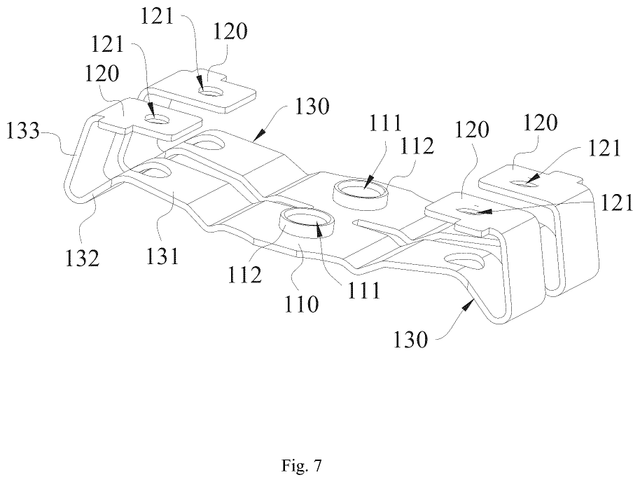

As shown in FIG. 7, the elastic piece 100 is disposed on the second side of the movable contact piece 3110, and two connection portions 120 and two deformation portions 130 are disposed on each side of the base portion 110 in the first direction D1, and each side of the base portion 110 along the first direction D1 is connected to the two connection portions 120 through the two deformation portions 130.

In the embodiment of the present disclosure, the elastic piece 100 includes a base portion 110, a connection portion 120 and a deformation portion 130. The base portion 110 is connected to the push rod 3210 through the first anti-rotation structure 300, and the connection portion 120 is connected to the movable contact assembly 3100 through the second anti-rotation structure 400. The deformation portion 130 can be deformed to provide contact pressure. The movable contact assembly 3100 is connected to the push rod 3210 through the elastic piece 100, and the movable contact assembly 3100 is prevented from rotating relative to the push rod 3210, thereby ensuring the consistency of the contact position between the movable contact assembly 3100 and the static contact leading-out terminal 2000, thus improving the reliability of the relay.

In addition, since the movable contact assembly 3100 cannot rotate, it can reduce to a certain extent or even prevent the movable contact assembly 3100 from contacting the side wall of the contact bracket 3220, thereby avoiding the generation of large ripple noise (metal friction noise). In addition, it is avoided that the matching clearance becomes larger due to the increase of friction times and severe wear, which leads to the increase of deflection force and friction resistance. Furthermore, it can also reduce the metal particles generated by the friction between the movable contact assembly 3100 and the contact bracket 3220, reduce the probability of metal particles falling on the contact surface of the contacts, and thus reduce the quality risk of contact resistance increasing or even non-conduction.

It should be noted that the first anti-rotation structure 300 is used to limit the relative rotation between the elastic piece 100 and the push rod assembly 3200 around the axis of the push rod assembly 3200, and the second anti-rotation structure 400 is used to limit the relative rotation between the elastic piece 100 and the movable contact assembly 3100 around the axis of the push rod assembly 3200, so that the elastic piece 100 can limit the rotation of the movable contact assembly 3100 relative to the push rod assembly 3200 around the axis of the push rod assembly 3200.

In other embodiments, the base portion 110 is connected to the movable contact assembly 3100 through the second anti-rotation structure 400, and the connection portion 120 is connected to t the push rod 3210 through the first anti-rotation structure 300.

It should be noted that, when the movable contact piece 3110 is in plurality, due to the anti-rotation function of the first anti-rotation structure 300 and the second anti-rotation structure 400, only one contact bracket 3220 may be used, thereby avoiding the need to provide a contact bracket 3220 for each movable contact piece 3110 and increasing the occupied space.

As shown in FIG. 6, the elastic piece 100 and the movable contact piece 3110 together enclose an accommodation chamber 200 for accommodating the second magnetizer 6200. The accommodation chamber 200 can play a role in avoiding the second magnetizer 6200, thereby preventing the elastic piece 100 from interfering with the second magnetizer 6200 during the over-travel process.

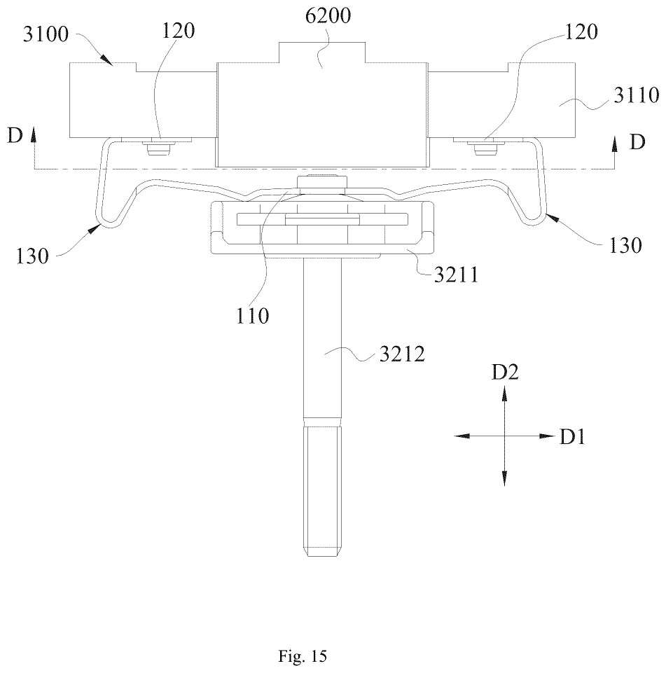

As shown in FIGS. 6 and 15, along the first direction D1, the connection portion 120 located at one side of the base portion 110 and with the movable contact assembly 3100 form a first joint 400a, and the connection portion 120 located at the other side of the base portion 110 and the movable contact assembly 3100 form a second joint 400b. There is a first distance L1 between the first joint 400a and the second joint 400b, and there is a second distance L2 between the deformation portions 130 on both sides of the base portion 110, and the first distance L1 is smaller than the second distance L2. Wherein the first distance L1 is the distance between the center line of the first joint 400a and the center line of the second joint 400b, and the second distance L2 is the maximum distance between the deformation portions 130 on both sides of the base portion 110.

In the embodiment of the present disclosure, since the first distance L1 is smaller than the second distance L2, during the over-travel process, the elastic piece 100 is compressed by the push rod 3210 and the movable contact assembly 3100, so that the deformation portion 130 on both sides of the base portion 110 can be deformed in a direction away from each other (the deformation portion 130 on both sides expands outward), thereby preventing the elastic piece 100 from being stuck and unable to provide contact pressure. In addition, since the first distance L1 is smaller than the second distance L2, the deformation portions 130 on both sides of the base portion 110 are equivalent to being bent in a direction close to each other as a whole, thereby reducing the overall volume of the elastic piece 100 and reducing the space occupancy rate.

Of course, in other embodiments, when the internal space of the relay is large enough, the first distance L1 may also be greater than the second distance L2.

The deformation portions 130 on both sides of the base portion 110 are first bent from both sides of the base portion 110 in the direction away from each other, and then bent in direction close to the movable contact assembly 3100 and close to each other.

As shown in FIG. 6, the connection portions 120 on both sides of the base portion 110 of the elastic piece 100 are respectively connected to both ends of the movable contact piece 3110 in the first direction D1, so that the movable contact assembly 3100 can be more stably connected to the elastic piece 100, further preventing the movable contact assembly 3100 from shaking and affecting the consistency of the contact point contact.

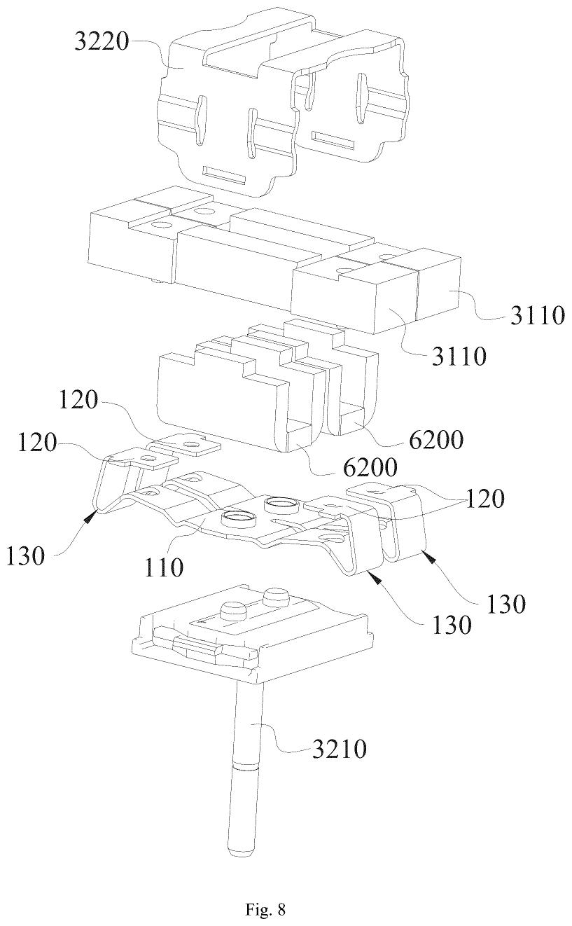

As shown in FIGS. 6 to 8, the movable contact assembly 3100 includes at least two movable contact pieces 3110 arranged side by side and at least two second magnetizers 6200. The at least two second magnetizers 6200 are fixedly connected to the at least two movable contact pieces 3110, respectively. At least two deformation portions 130 and at least two connection portions 120 are provided on each side of the base portion 110 of the elastic piece 100. The base portion 110 is connected to the push rod 3210 through the first anti-rotation structure 300. One side of the base portion 110 is connected to the at least two connection portions 120 through the at least two deformation portions 130, respectively. At least four connection portions 120 are connected to the at least two movable contact pieces 3110 of the movable contact assembly 3100 through the second anti-rotation structure 400.

In the embodiment of the present disclosure, the movable contact assembly 3100 includes two movable contact pieces 3110 and two second magnetizers 6200. Two deformation portions 130 and two connection portions 120 are disposed on each side of the base portion 110. Four connection portions 120 are divided into two pairs, and each pair of the connection portions 120 are disposed opposite to each other in the first direction D1. The two pairs of the connection portions 120 are connected to the two movable contact pieces 3110 through the second anti-rotation structure 400.

It can be seen that in the embodiment of the present disclosure, each movable contact piece 3110 corresponds to a pair of connection portions 120, so that when the contact gaps of the plurality of movable contact pieces 3110 and the static contact leading-out terminals are inconsistent, the plurality of movable contact pieces 3110 will not interfere with each other.

As shown in FIGS. 6 and 7, each deformation portion 130 includes a first section 131, a second section 132 and a third section 133. One end of the first section 131 is connected to the base portion 110; one end of the second section 132 is connected to the other end of the first section 131; The second section 132 is bent from the first section 131 in a direction away from the movable contact assembly 3100, and the second sections 132 on both sides of the base portion 110 are inclined relative to the axis of the push rod assembly 3200 in a direction away from each other; one end of the third section 133 is connected to the other end of the second section 132; The third section 133 is bent from the second section 132 in a direction close to the movable contact assembly 3100, and the third sections 133 on both sides of the base portion 110 are inclined relative to the axis of the push rod assembly 3200 in a direction close to each other. Wherein the other end of the third section 133 is connected to the connection portion 120, and the connection portion 120 on both sides of the base portion 110 extend from the third section 133 in a direction close to each other.

Further, a first bending joint 136 is formed between the first section 131 and the second section 132 of each deformation portion 130; along the second direction D2, the connection portion 120 corresponds to the position of the first bending joint 136.

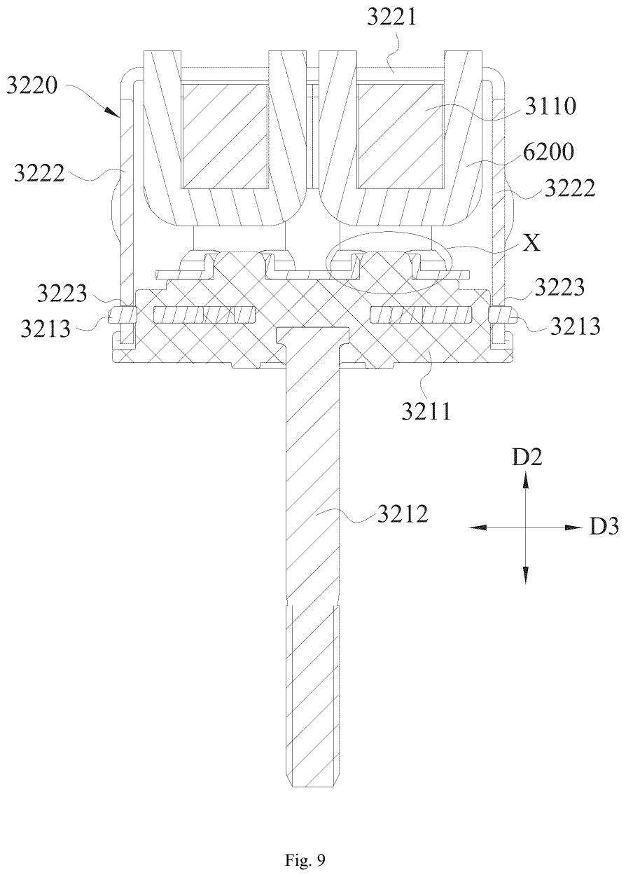

As shown in FIGS. 5, 7, 9 and 10, in one embodiment, the base portion 110 may be a sheet-like structure. The first anti-rotation structure 300 includes at least two first limiting holes 111 and at least two first limiting protrusions 3214. The at least two first limiting holes 111 are disposed on one of the elastic assembly 3230 and the push rod assembly 3200, and the at least two first limiting protrusions 3214 are disposed on the other one of the elastic assembly 3230 and the push rod assembly 3200.

In the embodiment of the present disclosure, the at least two first limiting holes 111 are provided in the base portion 110, the first limiting hole 111 can penetrate through both side surfaces of the base portion 110 in the thickness direction. The at least two first limiting protrusions 3214 are convexly provided on one side surface of the push rod 3210 facing the movable contact assembly 3100. The at least two first limiting protrusions 3214 are inserted into the at least two first limiting holes 111.

In the embodiment of the present disclosure, the at least two first limiting protrusions 3214 are provided on one side of the base 3211 of the push rod 3210 facing the static contact leading-out terminal 2000, and the at least two first limiting protrusions 3214 are arranged side by side along the third direction D3.

It should be noted that, since the first anti-rotation structure 300 of the embodiment of the present disclosure includes at least two first limiting protrusions 3214 and the first limiting holes 111 that cooperate with each other, the shape of the first limiting holes 111 can be circular.

Of course, in other embodiments, the first anti-rotation structure 300 may further include one first limiting protrusion 3214 and one first limiting hole 111, and the shape of the first limiting holes 111 is a non-circular shape such as a rectangle, an ellipse, or a triangle. The first limiting protrusion 3214 is adapted to the shape of the first limiting holes 111 and inserted into the first limiting holes 111, to prevent the push rod 3210 and the elastic piece 100 from rotating relative to each other.

It can be understood that the first anti-rotation structure 300 can prevent the elastic piece 100 from rotating about an axis perpendicular to the plane in which the movable contact piece 3110 is located.

It can be understood that, in other embodiments, the first anti-rotation structure 300 may also include a riveted structure, a welded structure, an adhesive structure, etc. When the first anti-rotation structure 300 is a riveted structure, the base portion 110 is riveted to the push rod assembly 3200; When the first anti-rotation structure 300 is a welded structure, the base portion 110 is welded to the push rod assembly 3200; When the first anti-rotation structure 300 is an adhesive structure, the base portion 110 is adhesively bonded to the push rod assembly 3200.

In another embodiment, the first anti-rotation structure 300 may further include a fastener that fastens the elastic piece 100 and the push rod assembly 3200.

As shown in FIG. 10, one side of the base portion 110 facing the movable contact piece 3110 is provided with a protruding ring 112 surrounding the first limiting hole 111, and the inner ring surface 112b of the protruding ring 112 is flush with the hole wall of the first limiting holes 111. Furthermore, the protruding ring 112 is formed by turning and bending the edge of the first limiting holes 111 of the base portion 110 toward the direction close to the movable contact piece 3110. By arranging the protruding ring 112 at the edge of the first limiting holes 111, the friction between the first limiting protrusions 3214 and the base portion 110 can be reduced when the base portion 110 and the push rod 3210 are assembled, and the generation of scraps can be prevented. In addition, the turned and bent protruding ring 112 can increase the contact area between the first limiting protrusions 3214 and the base portion 110, and reduce the wear between the first limiting protrusions 3214 and the first base portion 110 during movement.

The protruding ring 112 is provided with a top surface 112a facing away from the base portion 110, and a chamfer 113 is provided at the connection between the top surface 112a and the inner ring surface 112b. By providing the chamfer 113 at the connection between the top surface 112a and the inner ring surface 112b, burrs generated during the molding of the protruding ring 112 can be eliminated, and scraping can be further prevented from being generated between the first limiting protrusions 3214 and the inner ring surface 112b of the protruding ring 112.

As shown in FIGS. 6 and 7, the second anti-rotation structure 400 includes at least two second limiting holes 121 and at least two second limiting protrusions 3111. The at least two second limiting holes 121 are provided on one of the elastic assembly 3230 and the movable contact assembly 3100, and the at least two second limiting protrusions 3111 are provided on the other one of the elastic assembly 3230 and the movable contact assembly 3100.

In the embodiment of the present disclosure, there are four second limiting holes 121, and there are four second limiting protrusions 3111. The four second limiting holes 121 are respectively arranged on the four connection portions 120, and the four second limiting protrusions 3111 are arranged on two movable contact pieces 3110 of the movable contact assembly 3100, and both ends of the movable contact piece 3110 are respectively provided one of the second limiting protrusions 3111.

It can be understood that, in other embodiments, the second anti-rotation structure 400 may also include a riveted structure, a welded structure, or an adhesive structure, etc. When the second anti-rotation structure 400 is a riveted structure, the base portion 110 is riveted to the push rod assembly 3200; When the second anti-rotation structure 400 is a welded structure, the base portion 110 is welded to the push rod assembly 3200; When the second anti-rotation structure 400 is an adhesive structure, the base portion 110 is adhesively bonded to the push rod assembly 3200.

In another embodiment, the second anti-rotation structure 400 may further include a fastener that fastens the elastic piece 100 and the movable contact assembly 3100.

It can be understood that the first anti-rotation structure 300 and the second anti-rotation structure 400 can be the same or different. For example, the first anti-rotation structure 300 and the second anti-rotation structure 400 can both be a limiting connection structure or a fixed connection structure; or, the first anti-rotation structure 300 is a limiting connection structure, and the second anti-rotation structure 400 is a fixed connection structure.

In one embodiment, the elastic assembly 3230 and the movable contact assembly 3100 are connected in a limited way along the first direction D1; and/or, the elastic assembly 3230 and the push rod assembly 3200 are connected in a limited way along the first direction D1. In this way, the amplitude of the movable contact assembly 3100 in the first direction D1 relative to the push rod assembly 3200 can be reduced, thereby improving the overall impact resistance of the relay.

Preferably, the elastic assembly 3230 and the movable contact assembly 3100 are connected in a limited way along the first direction D1, and the elastic assembly 3230 and the push rod assembly 3200 are connected in a limited way along the first direction D1. In this way, when the relay encounters a large impact, there will be no displacement between the moving contact and the stationary contact, thus avoiding the instability of contact resistance.

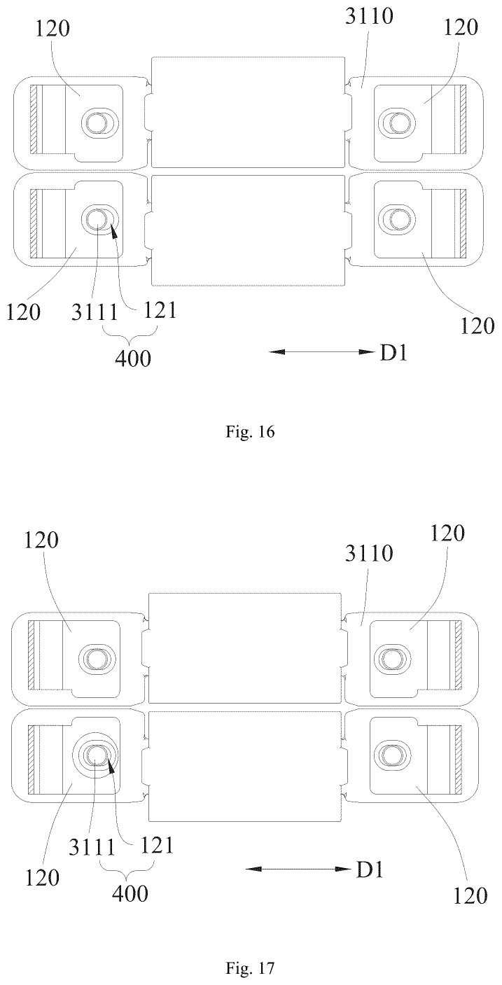

In another embodiment, as shown in FIGS. 16 and 17, each second limiting hole 121 of the second anti-rotation structure 400 is elliptical in shape, and the major axis of the ellipse is parallel with the first direction D1. By designing the second limiting holes 121 to be elliptical, before the movable contact and the static contact are in contact, the second limiting protrusions 3111 are limited to the outer edge of the second limiting holes 121, so that the movable contact assembly 3100 does not run (as shown in FIG. 16). After the movable contact and the static contact are in contact, the elastic piece 100 is compressed, and the connection portions 120 and the deformation portions 130 on both sides of the base portion 110 have a tendency to move toward both sides. At this time, the elliptical second limiting holes 121 can provide space for the connection portion 120 to move, so as to release the stress generated inside the elastic piece 100 after being compressed, and prevent the internal stress of the elastic piece 100 from being too concentrated and affecting its service life.

In addition, it is worth noting that, since the distance that the connection portion 120 moves within the ellipse is small, it does not affect the relative position of the moving contact and the static contact.

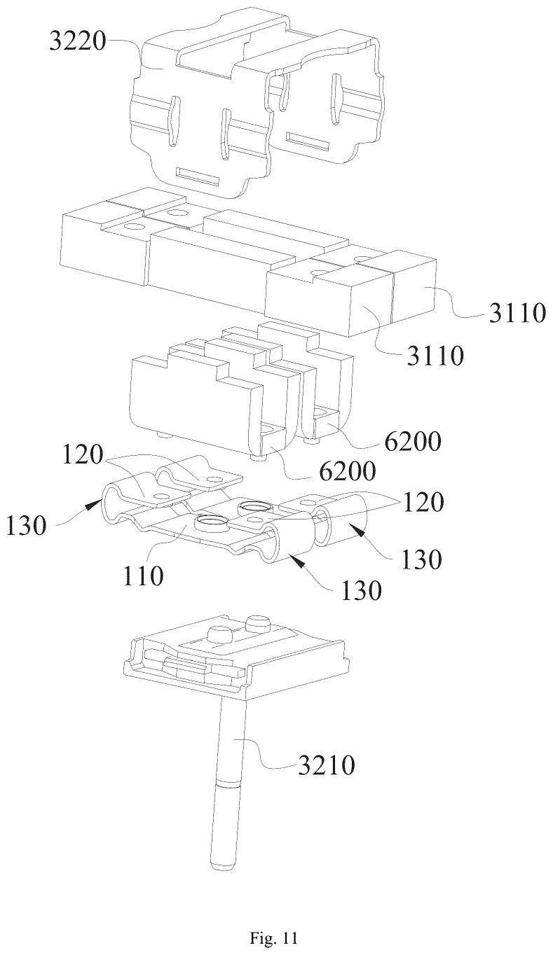

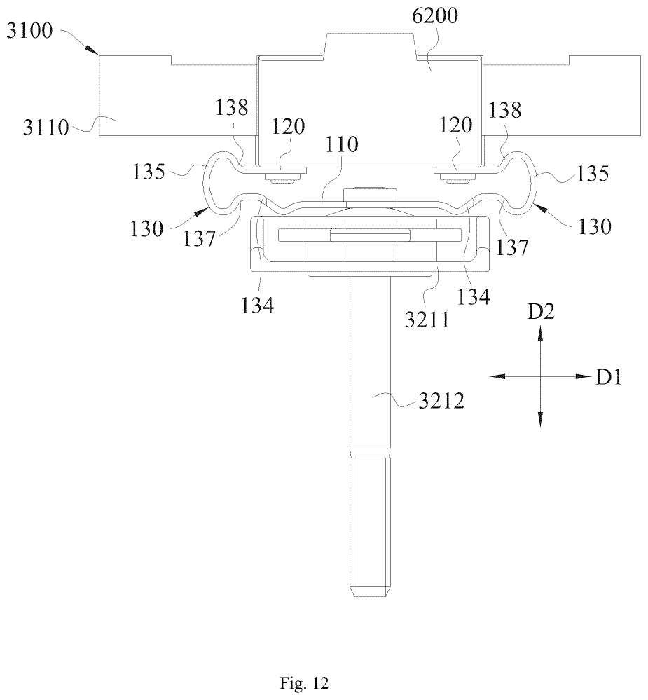

FIG. 11 and FIG. 12, the relay of the second embodiment has substantially the same basic structure as the relay of the first embodiment. Therefore, in the following description of the relay of the second embodiment, the structure already described in the first embodiment is not repeated. In addition, the same reference symbols are given to the same structures as those of the relay described in the first embodiment. Therefore, in the following description of this embodiment, the differences from the relay of the first embodiment are mainly described.

In the second embodiment, the connection portions 120 on both sides of the base portion 110 are connected to both ends of the second magnetizer 6200 along the first direction D1 through the second anti-rotation structure 400.

Each deformation portion 130 of the elastic piece 100 includes a fourth section 134 and a fifth section 135. One end of the fourth section 134 is connected to the base portion 110. The fifth section 135 is arc-shaped, and one end of the fifth section 135 is connected to the other end of the fourth section 134; the fifth section 135 extends from the fourth section 134 along an arc-shaped trajectory to the connection portion 120; Wherein the connection portions 120 on both sides of the base portion 110 extend from the fifth section 135 in a direction close to each other.

Further, the second bending joint 137 is formed between the fifth section 135 and the fourth section 134, and the third bending joint 138 is formed between the fifth section 135 and the connection portion 120. Along the second direction D2, the second bending joint 137 and the third bending joint 138 correspond in position.

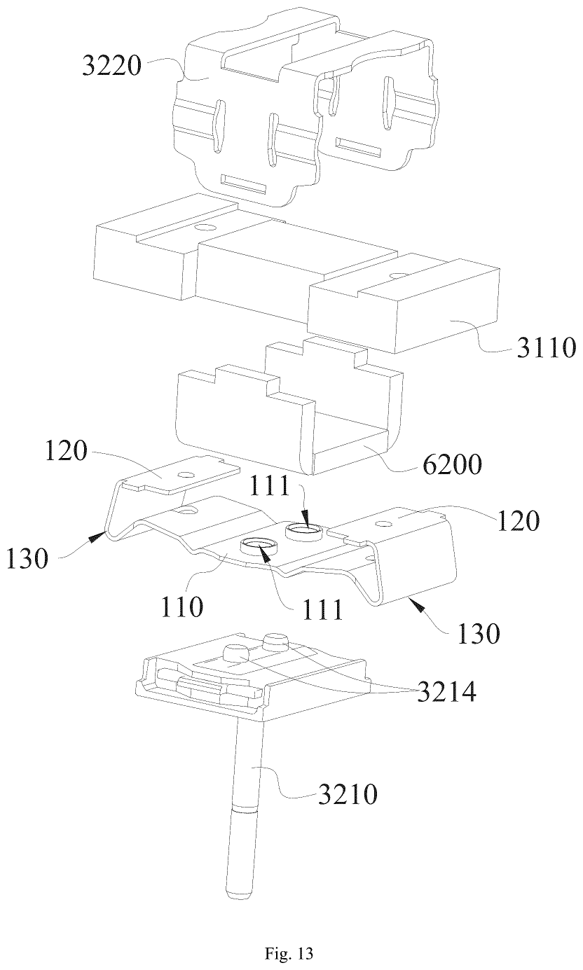

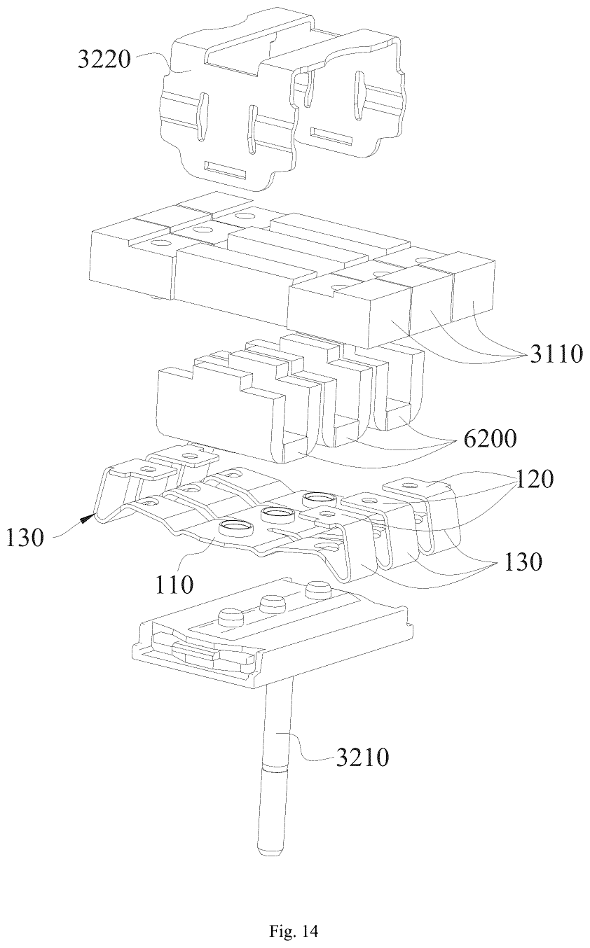

As shown in FIG. 13, the relay of the third embodiment has substantially the same basic structure as the relay of the first embodiment. Therefore, in the following description of the relay of the third embodiment, the structure already described in the first embodiment is not repeated. In addition, the same reference numerals are given to the same structures as those of the relay described in the first embodiment. Therefore, in the following description of this embodiment, the differences from the relay of the first embodiment are mainly described.

In the third embodiment, the movable contact assembly 3100 includes one movable contact piece 3110 and one second magnetizer 6200, and the relay includes one elastic piece 100. One connection portion 120 and one deformation portion 130 are provided on each side of the base portion 110 of the elastic piece 100.

In addition, the two first limiting protrusions 3214 of the first anti-rotation structure 300 can also be arranged along the first direction D1.

As shown in FIG. 1 to FIG. 4, the relay of the fourth embodiment has substantially the same basic structure as the relay of the first embodiment. Therefore, in the following description of the relay of the fourth embodiment, the structure already described in the first embodiment is not repeated. In addition, the same reference symbols are given to the same structures as those of the relay described in the first embodiment. Therefore, in the following description of this embodiment, the differences from the relay of the first embodiment are mainly described.

In the fourth embodiment, the movable contact assembly 3100 includes three movable contact pieces 3110 and three second magnetizers 6200. Three connection portions 120 and three deformation portions 130 are provided on each side of the base portion 110 of the elastic piece 100. The three connection portions 120 and the three deformation portions 130 are arranged side by side along the third direction D3. Each side of the base portion 110 is connected to the three connection portions 120 through the three deformation portions 130. The first anti-rotation structure 300 includes three first limiting protrusions 3214 and three first limiting holes 111.

It should be noted that in the relays in the first to fourth embodiments above, the anti-short circuit structure can also be a follow-up type, that is, the first magnetizer 6100 is fixedly connected to the top wall 3221 of the contact bracket 3220.

In addition, the elastic assembly 3230 is not limited to the elastic piece 100, for example, the elastic assembly 3230 may also include at least two compression springs, one ends of the at least two compression springs are connected to the push rod 3210 through the first anti-rotation structure 300, and the other ends of the at least two compression springs are connected to the movable contact assembly 3100 through the second anti-rotation structure 400.

It is understandable that the various embodiments/implementations provided in this application can be combined with each other without causing any contradiction, and will not be described one by one here.

In the application examples, the terms “first”, “second”, and “third” are used for descriptive purposes only and should not be understood as indicating or implying relative importance; the term “plurality” refers to two or more, unless otherwise clearly defined. The terms “installed”, “connected”, “connected”, “fixed” and the like should be understood in a broad sense. For example, “connected” can be a fixed connection, a detachable connection, or an integral connection; “connected” can be a direct connection or an indirect connection through an intermediate medium. For those of ordinary skill in the art, the specific meanings of the above terms in the application examples can be understood according to the specific circumstances.

In the description of the application embodiments, it should be understood that the terms “upper”, “lower”, “left”, “right”, “front”, “rear” and the like indicating directions or positional relationships are based on the directions or positional relationships shown in the drawings, and are only for the convenience of describing the application embodiments and simplifying the description, and do not indicate or imply that the device or unit referred to must have a specific direction, be constructed and operated in a specific direction, and therefore, cannot be understood as limiting the application embodiments.

In the description of this specification, the terms “one embodiment”, “some embodiments”, “specific embodiments”, etc. mean that the specific features, structures, materials or characteristics described in conjunction with the embodiment or example are included in at least one embodiment or example of the application embodiment. In this specification, the schematic representation of the above terms does not necessarily refer to the same embodiment or example. Moreover, the specific features, structures, materials or characteristics described can be combined in any one or more embodiments or examples in a suitable manner.

The above are only preferred embodiments of the application embodiments and are not intended to limit the application embodiments. For those skilled in the art, the application embodiments may have various changes and variations. Any modifications, equivalent replacements, improvements, etc. made within the spirit and principles of the application embodiments shall be included in the protection scope of the application embodiments.

What is claimed is:

1. A relay, comprising:
a movable contact assembly comprising a movable contact piece;
a push rod assembly configured to push the movable contact assembly to move so that the movable contact piece contacts with or separates from a static contact leading-out terminal; and
an elastic assembly connected to the push rod assembly through a first anti-rotation structure and connected to the movable contact assembly through a second anti-rotation structure, the elastic assembly is configured to provide a contact pressure and to limit the movable contact assembly from rotating relative to the push rod assembly around an axis of the push rod assembly.

2. The relay according to claim 1, wherein the relay further comprises a pair of static contact leading-out terminals, and two ends of the movable contact piece along a first direction are configured to respectively contact with or separate from the pair of static contact leading-out terminals; wherein the first direction is an arrangement direction of the pair of static contact leading-out terminals;
the elastic assembly is an elastic piece, and the elastic piece comprises a base portion, a connection portion and a deformation portion;
two ends of the base portion along the first direction are respectively provided with the connection portion and the deformation portion, the base portion is connected to the connection portion through the deformation portion, and the base portion is connected to the push rod assembly through the first anti-rotation structure;
the connection portion of the elastic piece is connected to the movable contact assembly through the second anti-rotation structure; wherein the deformation portion is configured to generate deformation to provide the contact pressure.

3. The relay according to claim 2, wherein along the first direction, the connection portion located at one side of the base portion and the movable contact assembly form a first joint, the connection portion located at another side of the base portion and the movable contact assembly form a second joint, there is a first distance between the first joint and the second joint, there is a second distance between the deformation portions on both sides of the base portion, and the first distance is smaller than the second distance;
wherein the second distance is a maximum distance between the deformation portions on both sides of the base portion.

4. The relay according to claim 2, wherein each deformation portion comprises:
a first section, one end of the first section is connected to the base portion;
a second section, one end of the second section is connected to another end of the first section; the second section is bent from the first section in a direction away from the movable contact assembly, and the second sections on both sides of the base portion are inclined relative to the axis of the push rod assembly in a direction away from each other; and
a third section, one end of the third section is connected to another end of the second section; the third section is bent from the second section toward the direction close to the movable contact assembly, and the third sections on both sides of the base portion are inclined relative to the axis of the push rod assembly in a direction close to each other;
wherein another end of the third section is connected to the connection portion, and the connection portions on both sides of the base portion extend from the third section in a direction close to each other.

5. The relay according to claim 2, wherein each deformation portion comprises:
a fourth section, one end of the fourth section is connected to the base portion;
a fifth section is arc-shaped; one end of the fifth section is connected to another end of the fourth section; the fifth section extends from the fourth section along an arc-shaped trajectory to the connection portion;
wherein connection portions on both sides of the base portion extend from the fifth section in a direction close to each other.

6. The relay according to claim 1, wherein the relay further comprises a pair of static contact leading-out terminals, and two ends of the movable contact piece along a first direction are configured to respectively contact with or separate from the pair of static contact leading-out terminals; wherein the first direction is an arrangement direction of the pair of static contact leading-out terminals;
the elastic assembly is an elastic piece, and the elastic piece comprises a base portion, a connection portion and a deformation portion;
both ends of the base portion along the first direction are respectively provided with the connection portion and the deformation portion, the base portion is connected to the connection portion through the deformation portion, and the base portion is connected to the movable contact assembly through the second anti-rotation structure;
the connection portion of the elastic piece is connected to the push rod assembly through the first anti-rotation structure; wherein the deformation portion is configured to generate deformation to provide the contact pressure.

7. The relay according to claim 1, wherein the elastic assembly is connected to the movable contact piece through the second anti-rotation structure.

8. The relay according to claim 1, wherein the relay further comprises a first magnetizer, the first magnetizer is disposed at a side of the movable contact piece facing the static contact leading-out terminal.

9. The relay according to claim 8, wherein, the movable contact assembly further comprises a second magnetizer, the second magnetizer is fixedly connected to a side of the movable contact piece facing away from the static contact leading-out terminal; the second magnetizer is configured to form a magnetic circuit with the first magnetizer;
the elastic assembly is connected to the second magnetizer through the second anti-rotation structure.

10. The relay according to claim 1, wherein the first anti-rotation structure comprises:
at least two first limiting holes provided on one of the elastic assembly and the push rod assembly; and
at least two first limiting protrusions arranged on another one of the push rod assembly and the elastic assembly; the at least two first limiting protrusions are inserted into the at least two first limiting holes.

11. The relay according to claim 10, wherein the elastic assembly is an elastic piece, and the elastic piece is provided with the at least two first limiting holes;
one side surface of the elastic piece facing the movable contact assembly is provided with at least two protruding rings the at least two protruding rings respectively surround the at least two first limiting holes, and an inner ring surface of the protruding ring is flush with a hole wall of the first limiting hole.

12. The relay according to claim 11, wherein the protruding ring is formed by turning and bending an edge of the first limiting hole of the elastic piece in a direction closing the movable contact assembly.

13. The relay according to claim 1, wherein the second anti-rotation structure comprises:
at least two second limiting holes provided on one of the elastic assembly and the movable contact assembly; and
at least two second limiting protrusions arranged on another one of the movable contact assembly and the elastic assembly; the at least two second limiting protrusions are inserted into at least two second limiting holes.

14. The relay according to claim 13, wherein the relay further comprises a pair of static contact leading-out terminals, and two ends of the movable contact piece along a first direction are configured to contact with or separate from the pair of static contact leading-out terminals respectively; wherein the first direction is an arrangement direction of the pair of static contact leading-out terminals;
each second limiting hole is elliptical, and a major axis of the ellipse is parallel with the first direction.

15. The relay according to claim 1, wherein the relay further comprises a pair of static contact leading-out terminals, and two ends of the movable contact piece along a first direction are configured to contact with or separate from the pair of static contact leading-out terminals respectively; wherein the first direction is an arrangement direction of the pair of static contact leading-out terminals;
the elastic assembly and the movable contact assembly are connected in a limited way along the first direction; and/or, the elastic assembly and the push rod assembly are connected in a limited way along the first direction.

16. The relay according to claim 1, wherein the push rod assembly comprises a contact bracket, the movable contact assembly comprises one or more movable contact pieces, and the movable contact assembly is installed in the contact bracket through the elastic assembly.
